(19) United States
(12) Patent Application Publication
(10) Pub. No.: US 2006/0255492 A1
(43) Pub. Date: Nov. 16, 2006

(54) In-mold decoration process

(76) Inventors: Chuan-Shien Yu, Taipei (TW); Lu-Chin Wu, Taipei Hsien (TW); Dean-Kuo Liu, Taoyuan Hsien (TW)

Correspondence Address: LOWE HAUPTMAN BERNER, LLP, 1700 DIAGONAL ROAD, SUITE 300, ALEXANDRIA, VA, 22314, US

(21) Appl. No.: 11/128,332

(22) Filed: May 13, 2005

(51) Int. Cl. B29C 45/14

(52) U.S. Cl. 264/132; 264/250; 264/255; 264/265; 264/161

(57) ABSTRACT

An In-Mold Decoration process has the following steps. A plastic film is provided. A hardening layer is formed under the plastic film. A metal film is formed under the hardening layer. A colored ink layer is coated under the metal film and is then baked. An appliqué, after being colored-ink coated, is preformed into a desired shape by heat and pressure. The preformed appliqué is then precisely trimmed. The appliqué is inserted into the mold cavity and a compatible material is injection molded behind the appliqué. A finished IMD product with metallic appearance is presented.

### BACKGROUND

1. Field of Invention

The present invention relates to an In-Mold Decoration process. More particularly, the present invention relates to an In-Mold Decoration process for enhancing adhesion and reliability of a metal film.

2. Description of Related Art

A conventional In-Mold Decoration (IMD) technology combines a film printing step, a preforming step and a mold injection step. When the above techniques are applied to different kinds of plastic films, various IMD products are produced, such as an outer housing for an electronic apparatus or an object of a car.

A transparent plastic film, formed on an exterior of an IMD product, can protect graphic designs thereunder from damage, such as scapre. Thus, this technology has gradually replaced a conventional process of directly printing graphics on a surface of an object.

If a metallic appearance of an IMD product is desired, a metal film needs to be integrated into the IMD process. A vacuum sputtering or evaporation deposition is generally applied to deposit the metal film under the plastic film. After depositing the metal film and printing the graphics, the plastic film is preformed with a desired shape.

Extra plastic materials are then trimmed away. Plastic appliqué is inserted into a mold cavity, and a compatible resin is injection molded therein. By using proper plastic materials and injection methods, an IMD product is then completed.

However, after a sputtering or evaporation deposition is integrated into the IMD process, an IMD appliqué suffers from weak adhesion between a metal film and a plastic film. The metal film may peel off the plastic film, detrimentally affecting the appearance thereof.

### SUMMARY

It is therefore an objective of the present invention to provide an In-Mold Decoration process so as to enhance adhesion and reliability of a metal film.

In accordance with the foregoing and other objectives of the present invention, an In-Mold Decoration process has following steps. A plastic film is provided. A hardening layer is formed under a plastic film. A metal film is formed under the hardening layer. A colored ink layer is coated under the metal film and is then baked. An appliqué, after being colored-ink coated, is preformed with a desired shape by heat and pressure. The appliqué is then precisely trimmed. The appliqué is inserted into the mold cavity and a compatible material is injection molded behind the appliqué. A finished IMD product with a metallic appearance results.

According to preferred embodiments, the hardening layer is a transparent metal oxide layer or metal oxide semiconductor layer, and its thickness is from 10 nm to 100 μm. The hardening layer can be an aluminum oxide, a titanium oxide, a silicon oxide, an indium-tin oxide, or a methane polymer. The hardening layer is formed by chemical vapor deposition or physical vapor deposition. The plastic film is made from a polycarbonate, acrylonitrile butadiene styrene, polyethylene terephthalate, acrylic or nylon material, and its thickness is from 0.125 mm to 0.8 mm. Additionally, the preforming step is conducted by a pressure pressing, a heat pressing, a vacuum pressing process, or any combination thereof. The metal film material can be gold, silver, copper, aluminum, nickel, chromium or any combination thereof. The metal film is formed by a vacuum sputtering or an evaporation deposition process. The colored ink layer can be coated or printed with UV curing ink or thermal curing ink.

Thus, this enhanced IMD process provides a hardening layer between the metal film and the plastic film to strengthen adhesion there-between.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flowchart of an In-Mold Decoration process according to one preferred embodiment; and

FIG. 2 illustrates a cross-sectional view of In-Mold Decoration product according to one preferred embodiment.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to overcome the weak adhesion between a metal film and a plastic film in an IMD (In-Model decoration) product, the present invention provides an enhanced IMD process. A hardening layer is coated between the metal film and the plastic film to strengthen the adhesion thereof.

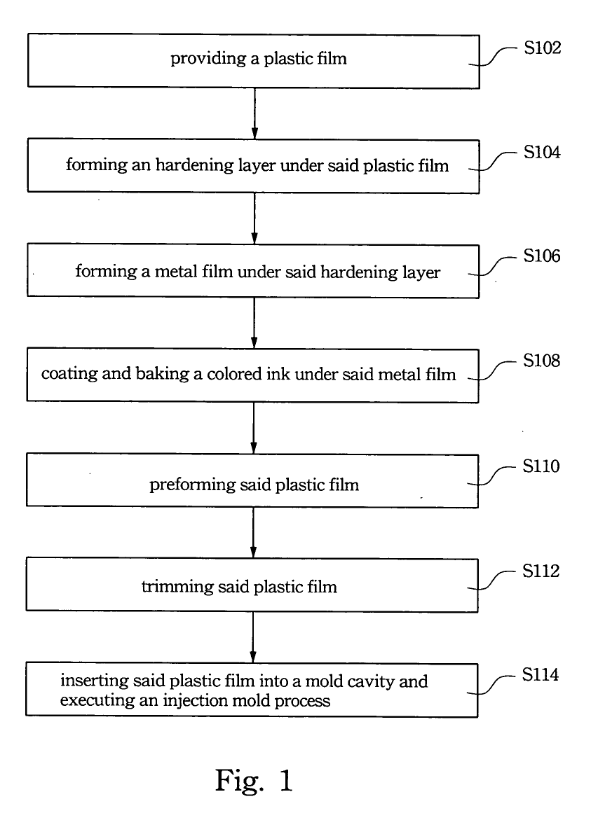

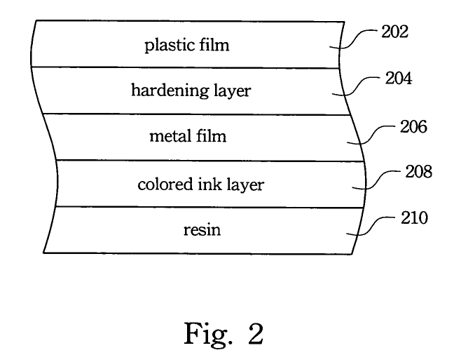

FIG. 1 is a flowchart of an In-Mold Decoration process and FIG. 2 illustrates a cross-sectional view of an In-Mold Decoration product.

Step 102 is described with reference to FIGS. 1 and 2. A plastic film 202 is provided. The plastic film 202 can be made from polycarbonate (PC), acrylonitrile butadiene styrene (ABS), polyethylene terephthalate (PET), acrylic, or nylon material. A thickness of the plastic film 202 is from 0.125 mm to 0.8 mm.

Step 104 is described with reference to FIGS. 1 and 2. A hardening layer 204 is formed under the plastic film 202 by chemical or physical vapor deposition (CVD or PVD). The physical vapor deposition can be a sputtering, evaporation deposition, or ion plating process. The hardening layer 204 can be a transparent metal oxide layer, a transparent metal oxide semiconductor layer, or a methane polymer. The transparent metal oxide layer can be an aluminum oxide or a titanium oxide layer. The transparent metal oxide semiconductor layer can be a silicon oxide or an indium-tin oxide layer. A thickness of the hardening layer of said hardening layer is from 10 nm to 100 μm.

Step 106 is described with reference to FIGS. 1 and 2. A metal film 206 is formed under the hardening layer 204 by a vacuum sputtering or an evaporation deposition so as to obtain a metallic appearance. The metal film 206 material can be gold, silver, copper, aluminum, nickel, chromium or any combination thereof. By controlling a film thickness, Perfect metallic appearances, such as total reflection or transparent character can be obtained.

Step 108 is described with reference to FIGS. 1 and 2. A colored ink layer 208 is coated under the metal film 206 and is then baked. The colored ink layer 208 can be coated or printed with UV curing ink or thermal curing ink.

Step 110 is described with reference to FIGS. 1 and 2. The plastic film 202 after colored ink coating is preformed into a desired shape. According to an desired IMD product's geometry patterns or designs, Step 110 can be adopted by a pressure pressing, a heat pressing, vacuum pressing process, or any combination thereof.

Step 112 is described with reference to FIGS. 1 and 2. A trimming process is used to remove extra plastic material thus obtain desired final shape.

Step 114 is described with reference to FIGS. 1 and 2. The plastic film 202 after Step 112 is manually or robotically inserted into a mold cavity and executing an injecting process. During Step 114, a compatible resin 210 is injection molded under the colored ink layer 208.

According to preferred embodiments, this enhanced IMD process coats a hardening layer 204, such as a transparent metal oxide layer, a transparent metal oxide semiconductor layer, or a methane polymer, between the metal film 206 and the plastic film 202 to strengthen adhesion there-between.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An In-Mold Decoration process, comprising:
providing a plastic film;
forming a hardening layer under said plastic film;
forming a metal film under said hardening layer;
coating a colored ink layer under said metal film and then baking said colored ink layer;
preforming said plastic film;
trimming said plastic film; and
inserting said plastic film into a mold cavity and executing an injection mold process.

2. The In-Mold Decoration process of claim 1, wherein said hardening layer is a transparent metal oxide layer or a transparent metal oxide semiconductor layer.

3. The In-Mold Decoration process of claim 2, wherein a thickness of said hardening layer is from about 10 nm to 100 μm.

4. The In-Mold Decoration process of claim 2, wherein said hardening layer includes an aluminum oxide or a titanium oxide material.

5. The In-Mold Decoration process of claim 1, wherein said hardening layer includes a silicon oxide or an indium tin oxide material.

6. The In-Mold Decoration process of claim 1, wherein said hardening layer includes a methane polymer.

7. The In-Mold Decoration process of claim 1, wherein said hardening layer is formed by chemical vapor deposition or physical vapor deposition.

8. The In-Mold Decoration process of claim 7, wherein said physical vapor deposition includes vacuum sputtering, evaporation deposition or ion plating.

9. The In-Mold Decoration process of claim 1, wherein said plastic film is made from a polycarbonate, acrylonitrile butadiene styrene, polyethylene terephthalate, acrylic, or nylon material.

10. The In-Mold Decoration process of claim 9, wherein a thickness of said plastic film is from about 0.125 mm to 0.8 mm.

11. The In-Mold Decoration process of claim 1, wherein said plastic film preformed by a pressure pressing, a heat pressing, a vacuum pressing process, or any combination thereof.

12. The In-Mold Decoration process of claim 1, wherein said metal film material includes gold, silver, copper, aluminum, nickel, chromium, or any combination thereof.

13. The In-Mold Decoration process of claim 12, wherein said metal film is formed by vacuum sputtering or evaporation deposition.

14. The In-Mold Decoration process of claim 1, wherein said colored ink layer includes UV curing ink or thermal curing ink.
